(19) United States
(12) Patent Application Publication
(10) Pub. No.: US 2024/0353222 A1
(43) Pub. Date: Oct. 24, 2024

(54) METHOD FOR GEAR TEETH MEASUREMENT

(71) Applicant: Klingelnberg GmbH, Hückeswagen (DE)

(72) Inventors: Jonas Stefer, Wipperfürth (DE); Markus Finkeldey, Hattingen (DE)

(21) Appl. No.: 18/641,991

(22) Filed: Apr. 22, 2024

(30) Foreign Application Priority Data
Apr. 20, 2023 (EP) 23169043.9

(51) Int. Cl. G01B 11/24

(52) U.S. Cl. CPC G01B 11/2416

(57) ABSTRACT

A method including the following steps of: providing a component, wherein the component has a gearing, wherein tooth flanks of the gearing have machining marks, determining at least one geometric feature of the machining marks, such as the height difference of the peaks and valleys, the flank-specific positions of the peaks and valleys, the offset or the like; carrying out an optical measurement of the gearing of the component, wherein a course of a measuring path for the optical measurement and/or wherein positions of measuring points for the optical measurement are defined taking into account the geometric feature of the machining marks and/or wherein an evaluation of measured values of the optical measurement is carried out taking into account the geometric feature of the machining marks.

### CROSS-REFERENCE TO RELATED APPLICATIONS

This application claims the benefit of European patent application no. 23169043.9 filed on 20 Apr. 2023, the disclosure of which is incorporated herein by reference in its entirety.

### TECHNICAL FIELD

The present disclosure relates to a method for gear teeth measurement.

### BACKGROUND

Components that have a gearing, such as gearwheels, are measured to check the quality of the manufactured gearing. The gear teeth measurement can take place between the individual machining steps, e.g. after soft machining and/or after hard fine machining.

The document DE 10 2016 006 957 A1 describes a method for tactile gear teeth measurement. The tactile gear teeth measurement is carried out by means of a measuring probe which has, for example, a feeler ball. During the tactile measurement, the probe ball of the measuring probe is brought into contact with the tooth flanks of the gear teeth to be measured in order to record individual measured values or to follow a measuring path along a respective tooth flank.

According to the document DE 10 2016 006 957 A1, feed marks that occur as a result of the soft machining of a gearing by gear hobbing make the tactile measurement of such a hobbed, pre-cut component more difficult. According to DE 10 2016 006 957 A1, there is a risk, particularly for very narrow gears, that the measuring probe, which is specifically guided in a valley of a feed mark, is guided laterally out of the tooth contact during the measurement and loses contact with the tooth flank. In order to avoid this, DE 10 2016 006 957 A1 states that jumping movements are carried out which move the measuring probe back into the center of the tooth in an adjacent valley of an adjacent feed mark of a respective tooth flank in order to prevent the probe from running out of the tooth space.

The procedure described in document DE 10 2016 006 957 A1 has the disadvantage that executing the jumping movement is time-consuming and, depending on the tooth shape, requires a large number of additional measuring movements.

It is known that optical measuring systems are used instead of tactile gear teeth measurement in order to enable faster measurement of gear teeth. The documents DE 10 2019 107 188 A1 and EP 4 012 329 A1, which go back to the applicant, describe methods for the optical measurement of gear teeth, which specify an adaptation of the optical measurement to the gearing as well as an optimized evaluation of optically recorded measured values.

With regard to optical measurement, it was assumed that the challenges of measuring probe guidance discussed in DE 10 2016 006 957 A1 for tactile measurement do not play a role for the optical measurement solutions according to DE 10 2019 107 188 A1 and EP 4 012 329 A1, as there is no contact between the gearing and the optical sensor during optical measurement.

However, it has been shown that the optical measurement is also impaired by the feed marks of the soft machining or pre-cutting, so that further adaptations of the optical measurement beyond the teachings of documents DE 10 2019 107 188 A1 and EP 4 012 329 A1 are required to enable reliable optical measurement of a pre-cut component.

Investigations by the applicant have shown that the optical measurement is impaired, for example, by the varying probing angles resulting from the trough-shaped contour of the feed marks. In other words, depending on the point at which an optical measuring beam hits the respective feed mark, a different probing angle results in each case, which the surface of the tooth flank encloses with the optical axis of the optical measuring system.

The probing angle has a decisive influence on the quality of the image of a measuring point using the optical measuring system, so that the quality of the image of different measuring points varies greatly and measured values may be unusable depending on the height position of a feed mark at which the measuring point in question was recorded.

Depending on the measured variable to be recorded, the measurement result is also falsified by the feed marks if it is not known whether the measured value in question is to be assigned to a peak or a valley of the respective feed mark. For example, the results of a graduation measurement can thus be falsified.

A similar problem arises for the so-called enveloping cut deviations. In the literature, a distinction is often made between enveloping cut deviations and feed marks for gear hobbing. The distinction between enveloping cut deviations and feed marks is explained in more detail in the figure description.

In principle, both the enveloping cut deviations and the feed marks result from the fact that the perfect, e.g. involute tooth form cannot be achieved in continuous gear cutting processes with a geometrically defined cutting edge due to the finite number of cutting edges, but can only be approximated. This means that there is always a deviation resulting from the sequence of a finite number of individual cutting edges along the tooth flanks to be produced.

The enveloping cut deviations and feed marks are summarized below under the generic term “machining marks”. The generic term “machining marks” includes not only the terms “enveloping cut deviations” and “feed marks”, which are usually associated with gear hobbing, but also all those structures or deviations of a tooth flank that result from other continuous gear cutting processes with geometrically defined cutting edges, such as gear skiving.

### SUMMARY

The present disclosure is based on the technical problem of providing an improved method for optically measuring a gearing with machining marks.

The technical problem described above is solved by a method according to the independent claim. Further embodiments of the disclosure result from the dependent claims and the following description.

According to the disclosure, a method is provided, having the method steps of: providing a component, wherein the component has a gearing, wherein tooth flanks of the gearing have machining marks, wherein the machining marks have been produced by manufacturing the tooth flanks by means of a continuous chip-removing gear cutting process using a tool with geometrically determined cutting edges, such as hobbing, skiving or the like, wherein the machining marks form a respective surface profile with peaks and valleys on each of the tooth flanks, which has in each case been produced on the respective tooth flanks by the periodic engagement of the cutting edges during the continuous chip-removing gear cutting process, wherein a position of peaks and valleys of the machining marks in the tooth width direction is flank-specific, wherein the peaks and valleys of adjacent tooth flanks have an offset relative to one another with respect to their flank-specific position in the tooth width direction, and wherein the offset has been produced as a result of an axial advance of the tool in the tooth width direction during the continuous chip-removing gear cutting process; determining at least one geometric feature of the machining marks, such as the flank-specific positions of the peaks and valleys, the offset or the like; carrying out an optical measurement of the gearing of the component, wherein a course of a measuring path for the optical measurement and/or wherein positions of measuring points for the optical measurement are defined taking into account the geometric feature of the machining marks and/or wherein an evaluation of measured values of the optical measurement is carried out taking into account the geometric feature of the machining marks.

By taking at least one geometric feature of the machining marks into account for the optical measurement or its evaluation in accordance with the disclosure and thus the optical measurement and/or its evaluation is therefore adapted to take the machining marks into account, gear teeth which have machining marks can be measured optically reliably.

In particular, the method according to the disclosure enables faster measurement of gear teeth with machining marks, since optical measurement permits faster relative movements during the measurement compared to tactile measurement and, in addition, a significantly larger number of measuring points can be recorded per time unit, e.g. per second or per minute.

In particular, it may be provided that the determination of at least one geometric feature of the machining marks comprises the determination of several geometric features of the machining marks, namely the determination of the flank-specific positions of the peaks and valleys and the offset.

Furthermore, it may also be provided that the course of the measuring path for the optical measurement and/or the positions of measuring points for the optical measurement are defined by taking into account the geometric features of the machining marks, namely by taking into account the flank-specific positions of the peaks and valleys and the offset.

Alternatively or additionally, it may be provided that the evaluation of measured values of the optical measurement is carried out by taking into account the geometric features of the machining marks, namely by taking into account the flank-specific positions of the peaks and valleys and the offset.

When the present text refers to the “peak” and the “valley” of a machining mark, or to the “peaks” and the “valleys” of the machining marks, this refers to the respective minimum extension, i.e. the valley, and the respective maximum extension, i.e. the peak, of a respective machining mark, as measured normal to the nominal geometry of the tooth flank to be produced. The nominal geometry describes the geometry of the tooth flanks of the gearing to be produced, which has been theoretically specified as part of a gearing design and is to be produced as accurately as possible using practical gear cutting processes. In the present case, the nominal geometry to be produced in the continuous chip-removing gear cutting process using the tool with a geometrically defined cutting edge is used as a reference for determining the peaks and valleys.

It may be provided that the offset of the flank-specific position of the peaks and valleys of adjacent tooth flanks results in a spiral arrangement of the machining marks when viewed over the entire circumference of the gearing, that the determination of the at least one geometric feature of the machining marks comprises the determination of a gradient and an orientation of the spiral arrangement of the machining marks, that the performance of the optical measurement comprises the specification of the measuring path, wherein the measuring path is defined at least in sections as a measuring spiral winding around the gearing, wherein the measuring spiral has an orientation and a gradient and that the gradient and orientation of the measuring spiral is defined at least in sections identically to the gradient and orientation of the spiral arrangement of the machining marks and/or is defined at least in sections differently from the gradient and/or orientation of the spiral arrangement of the machining marks.

If the gradient and orientation of the measuring spiral is defined in sections to be identical to the gradient and orientation of the spiral arrangement of the machining marks, it can be ensured in this region that the recorded measured values are specifically recorded at defined height positions of the machining marks in order to avoid measurement errors caused by the machining marks during the measurement. In particular, it may be provided that at least a subset of the measuring points to be recorded are arranged at equidistant distances from each other along the measuring spiral, in particular at equidistant angular distances from each other.

If the gradient and orientation of the measuring spiral is not defined in sections as identical to the gradient and orientation of the spiral arrangement of the machining marks, it can be ensured in this region that the recorded measured values are specifically recorded at defined height positions of the machining marks in order to avoid measurement errors caused by the machining marks during the measurement. In particular, it may be provided that at least a subset of the measuring points to be recorded are arranged along the measuring spiral at equidistant distances from one another, in particular at equidistant angular distances from one another. In other words, if the spiral arrangement of the machining marks is known, a measuring spiral defined differently from the spiral arrangement can also be used, along which measured values can be recorded that are always recorded at defined height positions of the machining marks in order to avoid measurement errors caused by the machining marks during the measurement. In particular, it may be provided that at least a subset of the measuring points to be recorded are arranged along the measuring spiral at equidistant distances from one another, in particular at equidistant angular distances from one another.

The gradient and orientation of the spiral arrangement of the machining marks can be determined by calculation using an evaluation of the production parameters of the chip-removing gear cutting process. For example, for a gear hobbing or skiving process, the position of the cuts, i.e. the machining marks, can be calculated for specific flanks using the tool geometry, the gearing and the set feeding movements, such as the set feed rates and the like.

Alternatively or additionally, it may be provided that the gradient and orientation of the spiral arrangement of the machining marks is determined by measurement using an evaluation of measurement data. The measurement data for determining the gradient and orientation of the spiral arrangement can be recorded before or during the optical measurement. In other words, a separate measurement can be carried out first, namely optically and/or in a tactile manner, in order to record the gradient and orientation of the spiral arrangement of the machining marks metrologically before the optical measurement of the gearing of the component is carried out. Alternatively, it may be provided that the gradient and orientation of the spiral arrangement of the machining marks is determined during the optical measurement of the gearing of the component, with the gradient and orientation of the spiral arrangement of the machining marks being taken into account when evaluating the measured values of the optical measurement.

Alternatively or additionally, it may be provided that the gradient and orientation of the spiral arrangement of the machining marks is determined by calculation using an evaluation of the manufacturing parameters of a chip-removing gear cutting process of comparable components. In this way, manufacturing processes with comparable process parameters can be used to estimate which gradient and orientation the spiral arrangement of the machining marks of the gearing is likely to have in order to carry out an initial optical measurement of the gearing of the component.

It may be provided that the gradient of the measuring spiral corresponds, at least in sections, to more than twice the gradient of the spiral arrangement of the machining marks or that the gradient of the measuring spiral corresponds, at least in sections, to less than half the gradient of the spiral arrangement of the machining marks. The measuring spiral can therefore be selected to deviate significantly from the gradient of the spiral arrangement of the machining marks.

According to one embodiment of the method, it may be provided that the measuring spiral covers an angular range of 1080° or less in relation to an axis of rotation of the gearing, in particular that the measuring spiral covers an angular range of 720° or less in relation to an axis of rotation of the gearing. In this way, a rapid optical measurement of the gearing can be achieved.

Alternatively or additionally, it may be provided that the measuring spiral covers 50% or more of the tooth width of the gearing, in particular 75% or more of the tooth width of the gearing.

To the extent that the foregoing aspects are combined, it may be provided, for example, that the measuring spiral covers an angular range of 720° or less with respect to an axis of rotation of the gearing and covers 75% or more of the tooth width of the gearing in order to achieve a rapid optical measurement of substantially the entire gearing, or to rapidly acquire measured values along the majority of the tooth width along the entire circumference of the gearing.

According to one embodiment of the method, it may be provided that the peaks and valleys have a height difference relative to one another, wherein the height difference is measured in a direction normal to a nominal geometry of the tooth flank to be generated during the chip-removing gear cutting process, that the evaluation of measuring points from tooth flank to tooth flank is carried out along the height difference of the machining marks as viewed for each of the machining marks at the same height position of a respective machining mark of the respective tooth flank. In this way, the influence of the machining marks on the measurement result during the evaluation of the measuring points can be eliminated or at least greatly reduced.

Alternatively or additionally, it may be provided that the detection of measuring points from tooth flank to tooth flank is carried out along the height difference of the machining marks, as viewed for each of the machining marks at the same height position of a respective machining mark of the respective tooth flank. In this way, the influence of the machining marks on the measurement result can already be eliminated or at least greatly reduced during the acquisition of the measuring points.

It may be provided that the determination of the at least one geometric feature of the machining marks comprises the determination of the height difference of the peaks and valleys.

It may be provided that the determination of the at least one geometric feature of the machining marks is carried out by calculation on the basis of an evaluation of production parameters of the chip-removing gear cutting process. For example, for a gear hobbing process or a gear skiving process, the position of the cuts, i.e. the machining marks, can be calculated flank-specifically using the tool geometry, the gearing and the set feed movements, such as the set feed rates and the like. The dimensions of the machining marks, i.e. their height difference, width and length, can also be calculated.

The calculation of the height difference of the peaks and valleys is described, for example, in Klocke, Fritz; Brecher, Christian: “Zahnrad-und Getriebetechnik” (Gear and Transmission Technology), 1st edition, Hanser Verlag, 2016, ISBN 978-3-446-43068-6, on pages 193, 194. In this textbook, the height difference is referred to as the feed mark depth.

Alternatively or additionally, it may be provided that the determination of the at least one geometric feature of the machining marks is carried out metrologically using an evaluation of measurement data. The measurement data for determining the at least one geometric feature of the machining marks can be recorded before or during the optical measurement. In other words, a separate measurement can be carried out first, namely optically and/or in a tactile manner, in order to detect the at least one geometric feature of the machining marks metrologically before the optical measurement of the gearing of the component is carried out. Alternatively, it may be provided that the determination of the at least one geometric feature of the machining marks takes place during the optical measurement of the gearing of the component, wherein the at least one geometric feature of the machining marks is taken into account when evaluating the measured values of the optical measurement. In particular, the position of the cuts, i.e. the machining marks, can be measured flank-specifically. Furthermore, the dimensions of the machining marks, i.e. their height difference, width and length, can be calculated.

Alternatively or additionally, it may be provided that the determination of the at least one geometric feature of the machining marks is carried out by calculation on the basis of an evaluation of manufacturing parameters of a chip-removing gear cutting process of comparable components.

It may be provided that an optical distance sensor is used for optical distance measurement, wherein the optical distance sensor is a point sensor, such as a confocal chromatic distance sensor or the like.

According to one embodiment of the method, it may be provided that profile lines of the tooth flanks are detected by means of the optical measurement and, for example, a pitch of the gearing is determined on the basis of the profile lines. According to one embodiment of the method, it may be provided that flank lines of the tooth flanks are detected by means of the optical measurement. According to one embodiment of the method, it may be provided that measuring grids and/or individual measuring points on the respective tooth flanks are detected by means of the optical measurement. It is understood that, as an alternative or in addition to determining the pitch, one or more of the following tooth pitch deviations are determined: Pitch deviations, such as the individual pitch deviation, the pitch sum deviation, the pitch step or the like, tooth thickness deviations, concentricity deviations, roundness deviations; axial run-out deviations; flatness deviations; torsion/entanglement.

According to one embodiment of the method, it may be provided that one or more of the following are detected by means of the optical measurement: Profile deviations, such as the total profile deviation, the profile shape deviation, the profile angle deviation, the pressure angle deviation or the like, and/or the deviations of one or more tooth flank modifications in the profile direction, such as deviations of the crowning, the tip and/or root relief, the profile angle modification, the profile entanglement or the like, flank line deviations, such as the total flank line deviation, the flank line shape deviation, the flank line angle deviation, the spiral angle deviation or the like and/or the deviations of one or more tooth flank modifications in the flank direction, such as deviations of the width crowning, the end reliefs, the flank line angle modification, the flank line entanglement or the like.

It may be provided that the chip-removing gear cutting process is a soft machining process and/or that the optical measurement of the gearing of the component takes place before hardening and/or before hard finishing of the gearing and/or that the gearing is helical gearing.

### BRIEF DESCRIPTION OF THE DRAWINGS

The disclosure is described in more detail below with reference to drawings illustrating embodiments, wherein they show schematically in each case:

FIG. 1 shows a top view of a gearwheel with a hob cutter;

FIG. 2 shows a perspective view of the gearwheel from FIG. 1 from above;

FIG. 3A shows feed marks;

FIG. 3B shows enveloping cut deviations;

FIG. 3C shows feed marks and enveloping cut deviations;

FIG. 3D shows the formation of feed marks;

FIG. 3E shows the formation of enveloping cut deviations;

FIG. 4 shows a tooth pitch of the gearwheel from FIG. 1;

FIG. 5 shows an enlarged view of the feed marks and enveloping cut deviations;

FIG. 6 shows a section VI-VI according to FIG. 5;

FIG. 7 shows a gradient of the feed marks;

FIG. 8 shows an optical measurement of the gearwheel from FIG. 1;

FIG. 9 shows a comparison of a measuring path and the gradient of the feed marks;

FIG. 10 shows a coordinate measuring machine for gear teeth measurement; and

FIG. 11 shows a flow chart of a method according to the disclosure.

### DETAILED DESCRIPTION OF THE DRAWINGS

FIG. 1 shows component 2 with a gearing 3. Component 2 is a helical spur gear. FIG. 1 also shows a hob cutter 4. The hob cutter 4 is used for machining or producing teeth 6 of the gearing 3 of the spur gear 2 with a geometrically defined cutting edge. A Cartesian coordinate system X, Y, Z is introduced to make the following explanations easier to understand.

During machining, the spur gear 2 and the hob cutter 4 perform a coupled relative movement, wherein the spur gear 2 and the hob cutter 4 each rotate around their own axis and the hob cutter 4 also feeds in the Z direction in order to machine the tooth flanks 8 of the teeth 6 of the spur gear 2 along their entire tooth width. The helical spur gear 2 is also referred to synonymously below as gearwheel 2.

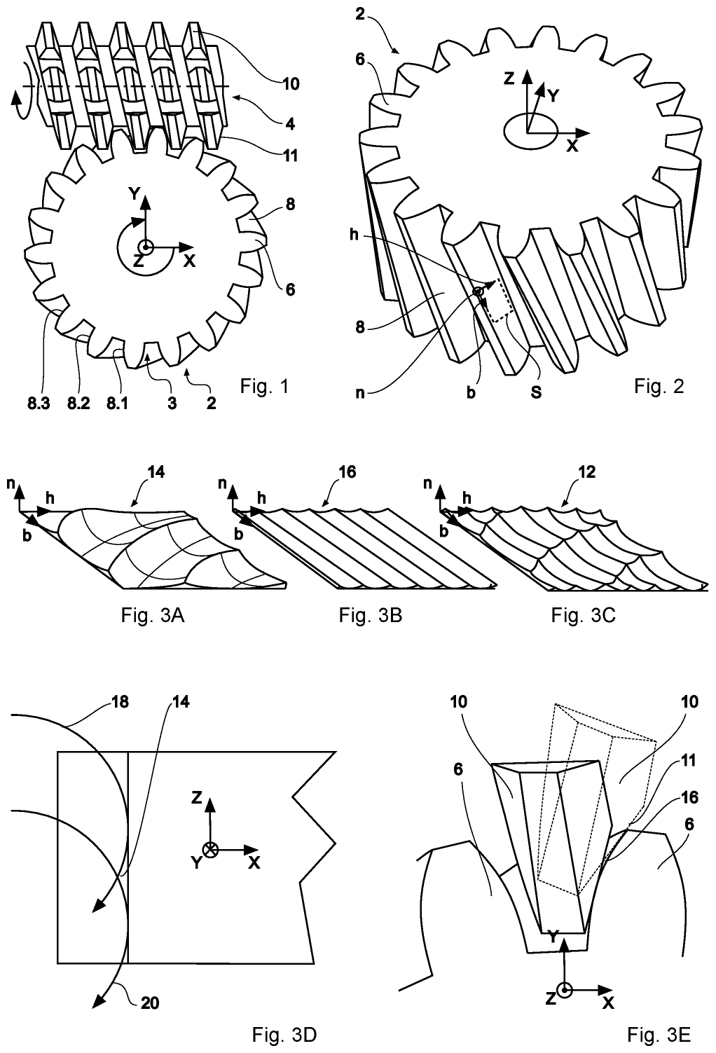

FIG. 2 shows the helical spur gear 2 in a perspective view from above. A local coordinate system b, h, n is introduced as an example, wherein the coordinate b represents a width direction of a tooth flank 8, the coordinate h represents a height direction of a tooth flank 8 and a coordinate n represents a normal direction relative to the nominal geometry of the tooth flank 8 to be manufactured.

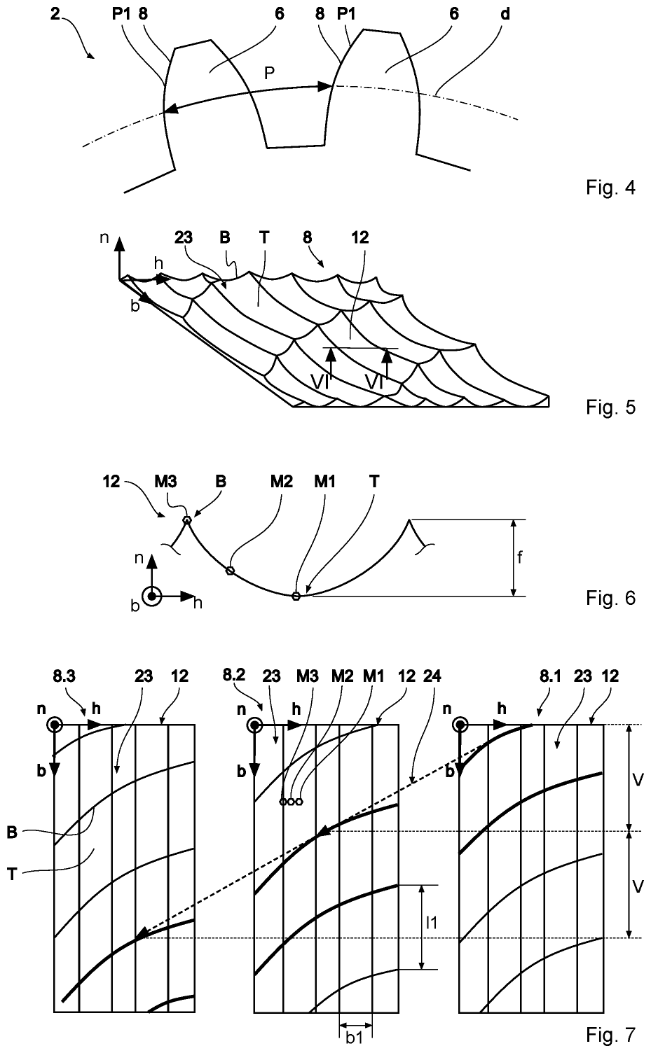

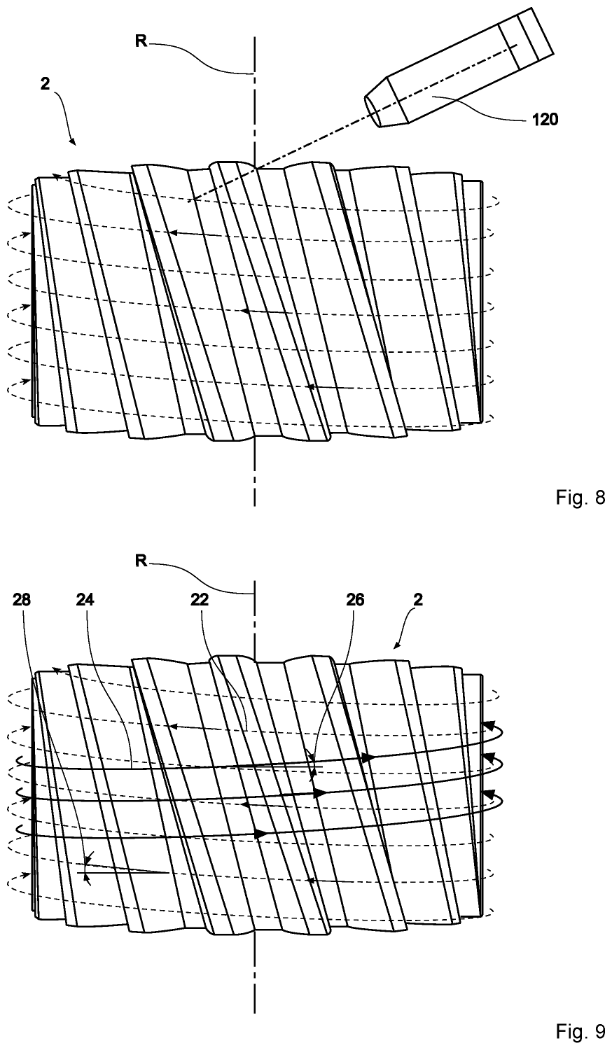

As can be seen in FIG. 1, the hob cutter 4 has a finite number of cutting teeth 10, which can only approximate the involute shape of the teeth 6 of the spur gear 2 through a finite number of individual cuts. The gear hobbing process therefore produces the machining marks 12 shown in FIG. 3C on the tooth flanks 8. FIG. 3C schematically shows an enlarged view of the individual feature S of a tooth flank 8 after machining by gear hobbing.

The machining marks 12 according to FIG. 3C are the result of a superposition of the feed marks 14 shown individually by way of example in FIG. 3A and the enveloping cut deviations 16 shown individually by way of example in FIG. 3B. The machining marks 12 therefore comprise feed marks 14 and enveloping cut deviations 16.

It is understood that the feed marks 14 and the enveloping cut deviations 16 in the separate form shown in FIG. 3A and FIG. 3B do not occur individually, but always occur together during hobbing in the form shown in FIG. 3C. FIG. 3A and FIG. 3B merely serve to break down and illustrate the relative kinematics and the resulting deviations into two components.

The feed marks 14 shown as an example in FIG. 3A result from the feed of the hob cutter 4 in the Z direction during the coupled relative movement. FIG. 3D shows an example of the cutter paths 18, 20 of successive cuts occurring after a workpiece revolution and a resulting feed mark 14.

FIG. 3E shows an example of the formation of enveloping cut deviations 16 resulting from the coupled rolling motion between the gearwheel 2 and the hob cutter 4 with its finite number of cutting teeth 10, wherein again a single enveloping cut deviation 16 resulting from successive cuts of the cutting teeth 10 of the hob cutter 4 is shown.

Due to the machining marks 12, a measurement of the geometry of the gearwheel 2 machined by hobbing can be falsified. FIG. 4 shows an example of a tooth pitch P of the gearwheel 2 on the pitch circle d, wherein the measurement of the tooth pitch P is an example of a very frequently occurring measurement task in gear technology.

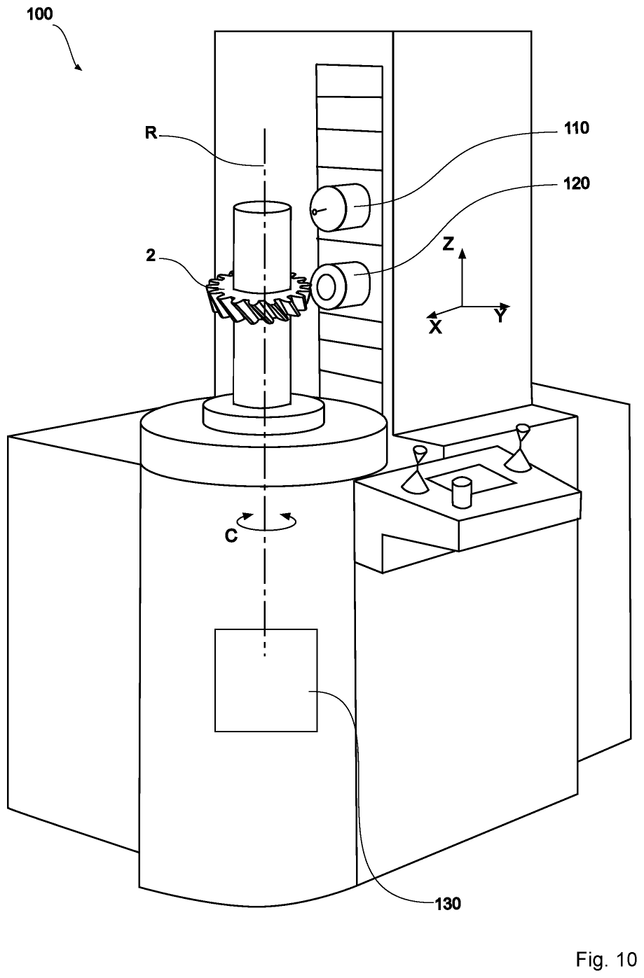

Depending on whether a measuring point on a relevant tooth flank 8 has been recorded in a valley T of a machining mark 12 or on a peak B of a machining mark 12, different measured values for the tooth pitch P are obtained (see FIG. 6). FIG. 6 illustrates an example of a section through a machining mark 12 as shown in FIG. 5.

FIG. 6 also shows an example of a measuring point M1 in the valley T of the machining mark 12, a measuring point M2 between the peak B and the valley T of the machining mark 12 and a measuring point M3 on the peak B of the machining mark 12. The height difference f of the machining mark 12 and the resulting maximum error are marked with reference sign f. It can therefore be seen that the measurement of the pitch P can be falsified by an amount between 0 and f depending on the height position of the measured value recording at a machining mark 12. The measuring points M1, M2, M3 are also shown as examples in FIG. 7, which is described in detail later. The measuring angle or probing angle, i.e. the angle that the surface of the tooth flank makes with the optical axis of the optical measuring device, also changes depending on the height position of the relevant measuring point. The decision as to whether a measurement is made for the respective machining mark at a measuring point M1, M2 or M3 can therefore also be made depending on which of these measuring points M1, M2, M3 has a probing angle that favors the optical measurement, i.e. the quality of the image of the respective measuring point.

In particular, it is proposed to record and/or evaluate measured values in the course of an optical measurement of the gearing 3 for each of the tooth flanks to be measured, for example always in a valley T of a respective machining mark 12 or on a peak B of a respective machining mark 12 or a defined intermediate position between a peak B and a valley T of a respective machining mark 12, in order to counteract the falsification of measurement results due to the machining marks 12.

In particular, it can be taken into account that the peaks B and valleys T of adjacent tooth flanks 8 have an offset relative to each other with regard to their flank-specific position in the tooth width direction, which is shown as an example in FIG. 7.

FIG. 7 is a highly simplified representation of the machining marks 12 in a plan view along the respective normal direction n on respective adjacent tooth flanks 8.1, 8.2, 8.3 (see FIG. 1).

According to FIG. 7, it can be seen that the peaks B and valleys T of the feed marks 12 shift from tooth flank 8.1 to tooth flank 8.2 to tooth flank 8.3 in the tooth width direction b, i.e. have an offset V in the tooth width direction b. The offset of the flank-specific position of the peaks B and valleys T of adjacent tooth flanks 8.1, 8.2, 8.3 results in a spiral arrangement 24 of the machining marks 12, which has a gradient and an orientation as indicated by the dashed arrows in FIG. 7, when viewed over the entire circumference of the gearing 3. The selected representations are schematized in order to illustrate the effects that are difficult to see with the naked eye in practice.

According to the disclosure, it may be provided to adapt an optical measurement to this spiral arrangement 24 of the machining marks 12, for example in order to specifically adapt a measuring path to the spiral arrangement 24 or to specifically specify a measuring path deviating from this spiral arrangement 24 of the machining marks 12.

FIG. 8 shows an example of a measuring path 22 winding spirally around the gearwheel 2, wherein in FIG. 9 the spiral arrangement 24 of the machining marks is schematically superimposed on this spiral measuring path 22. In this case, the spiral measuring path 22 has been deliberately selected to deviate from the gradient and orientation of the spiral arrangement 24 of the machining marks 12. The aim here is either to record exclusively measured values at the respective height positions M1 of the machining marks 12 or exclusively measured values at the respective height positions M2 of the machining marks 12 or exclusively measured values at the respective height positions M3 of the machining marks 12 already during the measurement or to evaluate only measured values of these height positions in order to eliminate or at least reduce the falsification of the measurement results of the optical measurement by the machining marks 12.

FIG. 10 shows a coordinate measuring machine 100 for gear measurement, which is set up to carry out the method according to the disclosure described in detail below. The coordinate measuring machine 100 has a tactile measuring device 110 for tactile gear measurement and an optical measuring device 120 for optical gear measurement.

The coordinate measuring machine 100 has an axis of rotation C for rotating the gearwheel 2 to be measured around its own axis. The coordinate measuring machine 100 has three linear axes X, Y, Z, which are designated X, Y, Z according to the respective degree of freedom. The optical measuring device 120 and the tactile measuring device 110 can therefore be translationally displaced relative to the gearwheel in three orthogonal spatial directions, which are also designated X, Y, Z. The coordinate measuring machine 100 has a controller 130 which is adapted to carry out the method according to the disclosure.

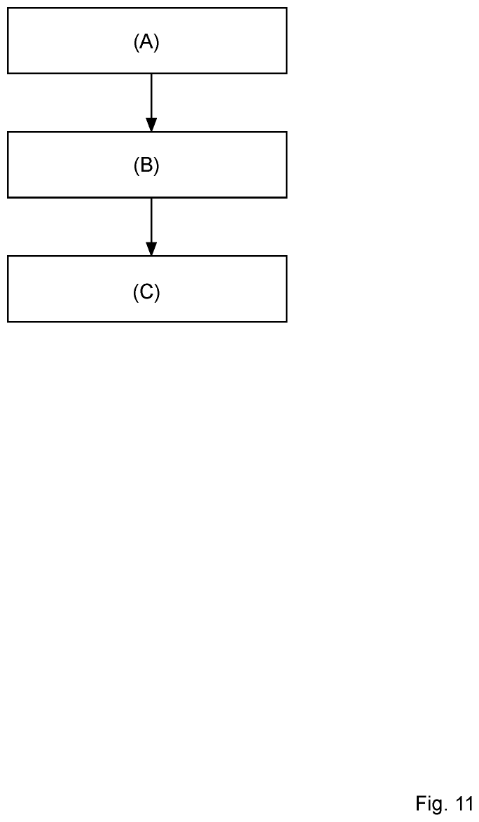

FIG. 11 shows exemplary method steps of the method according to the disclosure described below.

According to a first method step (A), the component 2 is first provided, wherein the component 2 has the gearing 3 with the teeth 6 and wherein the tooth flanks 8 of the gearing 6 have the machining marks 12.

The machining marks 12 have been created by producing the tooth flanks 8 using gear hobbing (FIG. 1).

On each of the tooth flanks 8, the machining marks 12 form a respective topographical surface profile 23 with peaks B and valleys T with a height difference f in the normal direction n to the nominal geometry of the tooth flank 8, which has been generated on the respective tooth flanks 8 by the periodic engagement of the cutting edges 11 of the teeth 10 of the hob cutter 4 during the continuous chip-removing gear cutting process.

The position of peaks B and valleys T of the machining marks in the tooth width direction b is flank-specific (FIG. 7).

The peaks 6 and valleys T of adjacent tooth flanks 8 have the offset V relative to each other with regard to their flank-specific position in the tooth width direction b. The offset V is generated as a result of the axial feed of the tool 4 in the tooth width direction b during gear hobbing.

According to a second method step (B), a plurality of geometric features of the machining marks 12 are determined, namely the height difference f, the flank-specific positions of the peaks B and valleys T and the offset—wherein the flank-specific positions of the peaks B and valleys T can be determined from the offset, and vice versa.

According to a third method step (C), an optical measurement of the gearing 3 of the component 2 is carried out, wherein a course of the measuring path 22 for the optical measurement and/or wherein positions of measuring points for the optical measurement are defined taking into account the geometric features of the machining marks 12 and/or wherein an evaluation of measured values of the optical measurement is carried out taking into account the geometric features of the machining marks.

In the present case, the offset V of the flank-specific position of the peaks B and valleys T of adjacent tooth flanks 8, 8.1, 8.2, 8.3 results in a spiral arrangement 24 of the machining marks 12 when viewed over the entire circumference of the gearing 3.

The determination of the geometric features of the machining marks 12 includes the determination of the gradient 26 and the orientation of the spiral arrangement 24 of the machining marks 12.

The performance of the optical measurement has the specification of the measuring path 22, wherein the measuring path 22 is defined at least in sections as a measuring spiral 22 and wherein the measuring spiral 22 has an orientation and a gradient 28.

In the present case, the measuring spiral 22 is oriented to the left and the spiral arrangement 24 is oriented to the right. The gradient 28 of the measuring spiral 24 is greater than the gradient 26 of the spiral arrangement 24. The gradient and orientation of the measuring spiral 22 is therefore oriented differently from the gradient and orientation of the spiral arrangement 24.

According to an alternative variant of the method, it is provided that the gradient and orientation of the measuring spiral correspond to the gradient and orientation of the spiral arrangement of the machining marks. In this case, the measuring spiral 22 and the spiral arrangement are congruent.

The gradient and orientation of the spiral arrangement of the machining marks can be determined by calculation using an evaluation of the production parameters of the gear hobbing process and/or can be determined by measurement using an evaluation of measurement data and/or can be determined by calculation using an evaluation of the production parameters of a chip-removing gear cutting process for comparable components.

The measuring spiral 22 covers an angular range of 1080° or less in relation to an axis of rotation R of the gearing 6.

The measuring spiral 22 covers more than 75% of the tooth width of the gearing 6 in relation to one tooth width.

It is provided that an evaluation of measuring points from tooth flank 8 to tooth flank 8 is carried out along the height difference f of the feed marks as viewed for each of the machining marks 12 at the same height position of a respective machining mark 12 of the respective tooth flank 8—either according to the height position M1 or M2 or M3, as shown by way of example in FIG. 6 and FIG. 7. In other words, measurement or evaluation is always carried out in the valley T or measurement or evaluation is always carried out on the peak B or evaluation is always carried out at a defined intermediate position between peak B and valley T in order to eliminate or at least reduce the influence of the height difference f of the topographical surface profile 23 on a measurement result.

The determination of the at least one geometric feature of the machining marks 12 involves the determination of several features of the features listed below: Height difference f of the machining marks 12, offset V, width b1 of the machining marks, length l1 of the machining marks.

A plurality of features of the machining marks can be determined by calculation using an evaluation of production parameters of the gear hobbing process, alternatively or additionally by measurement using an evaluation of measurement data or alternatively or additionally by calculation using an evaluation of production parameters of a chip-removing gear cutting process of comparable components.

The optical measuring device 120 used for optical measurement is an optical distance sensor for optical distance measurement, wherein the optical distance sensor is a point sensor, namely a confocal chromatic distance sensor.

In the present case, profile lines P1 of the tooth flanks are recorded by means of optical measurement and the pitch P of the gearing 6 is determined using the profile lines.

Gear hobbing is a soft machining process and the optical measurement of the gearing 3 of component 2 is carried out before hardening and/or before hard finishing of the gearing 3 of component 2.

1. A method for gear teeth measurement, the method including the following steps:
providing a component, wherein the component bas a gearing,
wherein tooth flanks of the gearing have machining marks.
wherein the machining marks have been produced by manufacturing the tooth flanks by means of a continuous chip-removing gear cutting process using a tool with geometrically defined cutting edges,
wherein the machining marks form a respective surface profile with peaks and valleys on each of the tooth flanks, which has in each case been produced on the respective tooth flanks by the periodic engagement of the cutting edges during the continuous chip-removing gear cutting process,
wherein a respective position of peaks and valleys of the machining marks in the tooth width direction is flank-specific,
wherein the peaks and valleys of adjacent tooth flanks have an offset relative to one another with respect to their flank-specific position in the tooth width direction, and wherein the offset has been produced as a result of an axial advance of the tool in the tooth width direction during the continuous chip-removing gear cutting process;
determining at least one geometric feature of the machining marks, such as the flank-specific positions of the peaks and valleys, the offset;
carrying out an optical measurement of the gearing of the component,
wherein a course of a measuring path for the optical measurement and/or wherein positions of measuring points for the optical measurement are defined taking into account the at least one geometric feature of the machining marks and/or
wherein an evaluation of measured values of the optical measurement is carried out taking into account the at least one geometric feature of the machining marks.

2. The method according to claim 1,
wherein
the offset of the flank-specific position of the peaks and valleys of adjacent tooth flanks results in a spiral arrangement of the machining marks when viewed over the entire circumference of the gearing,
the determination of the at least one geometric feature of the machining marks comprises the determination of a gradient and an orientation of the spiral arrangement of the machining marks,
the performance of the optical measurement comprises the specification of the measuring path, wherein the measuring path is defined at least in sections as a measuring spiral winding around the gearing, wherein the measuring spiral has an orientation and a gradient, and
the gradient and orientation of the measuring spiral is defined at least in sections identically to the gradient and orientation of the spiral arrangement of the machining marks and/or is defined at least in sections differently from the gradient-and/or orientation of the spiral arrangement of the machining marks.

3. The method according to claim 2,
wherein
the gradient and orientation of the spiral arrangement of the machining marks are determined by calculation using an evaluation of production parameters of the chip-removing gear cutting process
and/or
the gradient and orientation of the spiral arrangement of the machining marks are determined by measurement using an evaluation of measurement data
and/or
the gradient and orientation of the spiral arrangement of the machining marks are determined by calculation using an evaluation of production parameters of a chip-removing gear cutting process of comparable components.

4. The method according to claim 2,
wherein the gradient of the measuring spiral corresponds at least in sections to more than twice the gradient of the spiral arrangement of the machining marks or
wherein the gradient of the measuring spiral corresponds, at least in sections, to less than half the gradient of the spiral arrangement of the machining marks.

5. The method according to claim 2,
wherein the measuring spiral covers an angular range of 1080° or less in relation to an axis of rotation of the gearing,
and/or
wherein the measuring spiral covers 50% or more of the tooth width of the gearing in relation to a tooth width of the gearing.

6. The method according to claim 1,
wherein
the peaks and valleys have a height difference relative to one another, wherein the height difference is measured in a direction normal to a nominal geometry of the tooth flank to be produced in the chip-removing gear cutting process, and
wherein the evaluation of measuring points from tooth flank to tooth flank is carried out along the height difference of the machining marks as viewed for each of the machining marks at the same height position of a respective machining mark of the respective tooth flank and/or
wherein the detection of measuring points from tooth flank to tooth flank is carried out along the height difference of the machining marks, as viewed for each of the machining marks at the same height position of a respective machining mark of the respective tooth flank.

7. The method according to claim 6,
wherein the determination of the at least one geometric feature of the machining marks comprises the determination of the height difference of the peaks and valleys.

8. The method according to claim 1, wherein
the determination of the at least one geometric feature of the machining marks is carried out by calculation on the basis of an evaluation of production parameters of the chip-removing gear cutting process
and/or
the determination of the at least one geometric feature of the machining marks is carried out metrologically using an evaluation of measurement data
and/or
the determination of the at least one geometric feature of the machining marks is carried out by calculation on the basis of an evaluation of production parameters of a chip-removing gear cutting process of comparable components.

9. The method according to claim 1,
wherein
an optical distance sensor is used for optical distance measurement,
wherein the optical distance sensor is a point sensor.

10. The method according to claim 1,
wherein
profile lines of the tooth flanks are detected by means of the optical measurement and
a pitch of the gearing is determined using the profile lines.

11. The method according to claim 1,
wherein the gear cutting process is a soft machining process and/or
wherein the optical measurement of the gearing of the component takes place before hardening and/or before hard finishing of the gearing
and/or
wherein the gearing is helical gearing.
